(19) United States
(12) Patent Application Publication
(10) Pub. No.: US 2025/0229610 A1
(43) Pub. Date: Jul. 17, 2025

(54) Floating Truck Bed Shell

(71) Applicant: Jesus Espinoza Dominguez, Del Rio, TX (US)

(72) Inventor: Jesus Espinoza Dominguez, Del Rio, TX (US)

(21) Appl. No.: 19/013,361

(22) Filed: Jan. 8, 2025

Related U.S. Application Data
(60) Provisional application No. 63/621,695, filed on Jan. 17, 2024.

(51) Int. Cl. B60J 7/10

(52) U.S. Cl. CPC B60J 7/10

(57) ABSTRACT

A novel camper truck bed shell that functions as a conventional camper truck bed shell for pickup trucks and can transform into a small boat, offering recreational opportunities without the need for a separate boat is disclosed. The shell includes a body having a pair of side walls, a rear wall, a top wall and a front wall, the side walls are slidably positioned on a pair of sliding rails, the sliding rails are detachably positioned on the side walls of a truck bed, wherein the truck bed shell is adapted to be lifted from the truck bed to detach the sliding rails and sliding the shell to detach from the sliding rails and the truck bed. The detached shell is configured to be used as a boat and includes at least one seat for sitting of users.

### CROSS-REFERENCE TO RELATED APPLICATION

The present application claims priority to, and the benefit of, U.S. Provisional Application No. 63/621,695, which was filed on Jan. 17, 2024, and is incorporated herein by reference in its entirety.

### FIELD OF THE INVENTION

The present invention generally relates to the field of truck bed covers. More specifically, the present invention relates to a novel camper truck bed shell for all types of pickup truck makes and models. The device is adapted to be flipped onto the surface of a body of water to be used as a fishing boat. To use the device, the user may back their truck up towards the body of water before mechanically flipping the boat over and onto the water. The boat features a pair of seats that can be used by one or two individuals or pets. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals who enjoy fishing often do not have access to a boat whenever they wish to go fishing. Many individuals may not be able to afford to buy and maintain a boat. Boats enable anglers to access deeper waters, cover more area, and reach spots that are not accessible from the shore, leading to potentially more and better catches. Without a boat, anglers are limited to shore fishing, which may not be as productive. These limitations affect individuals' ability to fish as frequently or effectively as individuals might like. For those who do own or have access to a boat, transporting the boat to and from the water presents a challenging and time-consuming endeavor.

Further, renting a boat for fishing is not always feasible. The reasons include but are not limited to high rental costs, limited availability, especially during peak fishing seasons/periods, or the distance from rental facilities to preferred fishing locations, which adds to the inconvenience. Also, launching conventional boats into the water such as from a trailer is a challenging task, especially when an individual attempts to do it alone. Launching a boat can involve damage to the boat or the trailer. Individuals end up needing additional help to launch the boat wherein the help is not always available. Many vehicles and even pickup trucks are not suitable for carrying boats which pose challenges to individuals in carrying and using boats. Individuals desire an improved boat device that can be carried easily on a vehicle and provides easy hauling into water without any additional assistance.

Therefore, there exists a long felt need in the art for a device that can be carried easily on a truck and can also be used as a boat. There is also a long felt need in the art for a lightweight device that can be stored on truck bed and easily removed to be used as boat. Additionally, there is a long felt need in the art for a unique camper truck bed shell for all types of pickup trucks that can be converted into a small fishing boat. There is also a long felt need in the art for a camper truck bed shell that can be easily flipped upside-down from the truck bed rails and onto the water. Further, there is a long felt need in the art for an improved truck bed cover that eliminates the use of separate boats for fishing. Furthermore, there is a long felt need in the art for a device that looks like a regular camper truck bed shell which may be flipped onto the surface of the body of water to be used as a small fishing boat. Finally, there is a long felt need in the art for a novel camper truck bed shell that prevents individuals from having to haul extremely heavy and bulky fishing boats with a pickup truck.

The subject matter disclosed and claimed herein, in one embodiment thereof, comprises a camper truck bed shell. The camper truck bed shell further comprising a floating body with a pair of side walls, a front wall, a rear wall, and a top wall designed to provide buoyant force sufficient for flotation, a first and a second sliding rail disposed along the bottom edges of the respective side walls for facilitating sliding and rotation along a truck bed's edges, and at least one ergonomic and soft seating platform disposed within the inner area for user seating. The shell covers the truck bed and can be flipped to detach the sliding rails to remove the shell from the truck bed to be used as a boat for fishing and other recreational activities.

In this manner, the floating camper truck bed shell of the present invention accomplishes all of the forgoing objectives and provides users with a camper truck bed shell that has a dual-purpose design. The device functions as a conventional camper truck bed shell for pickup trucks, providing the usual benefits of extra covered space for cargo or camping and can also transform into a small fishing boat, offering recreational opportunities without the need for a separate boat. The device is designed to mechanically flip over onto the water, simplifying the process of transitioning from a camper truck bed shell to a boat. The seats in the device enable sitting of one or two individuals or pets and the device can accommodate a range of outdoor activities, from solo fishing trips to leisurely outings with a partner or a pet. The device can be designed to fit all types of pickup truck makes and models ensuring broad accessibility.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a camper truck bed shell. The camper truck bed shell further comprising a floating body with a pair of side walls, a front wall, a rear wall, and a top wall designed to provide buoyant force sufficient for flotation, a first and a second sliding rail disposed along the bottom edges of the respective side walls for facilitating sliding and rotation along a truck bed's edges, and at least one ergonomic and soft seating platform disposed within the inner area for user seating.

In another embodiment of the present invention, a floatable camper truck bed shell system is disclosed. The system further comprises a floatable body, the body includes a pair of side walls, a front wall, a rear wall and a top wall, the body has an installed position when positioned on a truck bed of a pickup truck. A pair of sliding rails including a first sliding rail and a second sliding rail are hingedly secured along the top edges of the side walls of the truck bed, the first sliding rail is detachably coupled to one of the pair of side walls of the body and the second sliding rail is detachably coupled to the other wall of the pair of side walls of the body, wherein the sliding rails are flipped to remove the body from the installed position to a pivoting position.

In another aspect, a camper truck bed shell adapted to transition between an installed position on a pickup truck and a pivoting position for detachment is disclosed. The shell includes a floatable body, a first sliding rail slidably and detachably fastened to a first side wall of the shell and a second sliding rail slidably and detachably fastened to a second side wall of the shell, the first and second sliding rails are pivotally fastened at their rear ends to a truck bed, enabling the camper truck bed shell to pivotally lift and rotate from the installed position to the pivoting position, wherein the camper truck bed shell flips over for detachment from the truck bed for use as a boat.

In another embodiment, a floating camper truck bed shell is disclosed. The floating camper truck bed shell includes a floating body adapted to cover a truck bed in an installed position and is adapted to be removed from the truck bed using a pair of sliding rails for use as a floating boat in a body of water, wherein the floating body has at least one seat for accommodating a user and a detachably attached outboard motor for driving the boat.

In yet another embodiment, a one-piece camper truck bed shell operatively and detachably placed on a truck bed is disclosed. The camper truck bed shell is adapted to cover truck bed in an installed position and is placed on the truck bed using a pair of pivoting sliding rails, the sliding rails are pivotally fastened to the rear ends thereof to the truck bed using hinges, wherein the camper truck bed shell is lifted along the pivotally fastened hinges to depart away from the truck bed and the camper truck bed shell is slid along the sliding rails to detach the camper truck bed shell, wherein the camper truck bed shell is configured to be used as a boat on a body of water and includes at least one seat for accommodation of users.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the floating camper truck bed shell of the present invention in accordance with the disclosed architecture;

FIG. 2 illustrates a perspective view of the floating camper truck bed shell of the present invention installed on a truck bed in accordance with the disclosed structure;

FIG. 3 illustrates a perspective view of the floating camper truck bed shell of the present invention in a pivoting position in accordance with the disclosed structure;

FIG. 4 illustrates a perspective view showing the camper truck bed shell of the present invention being flipped into a body of water to function like a boat in accordance with one embodiment of the present invention;

FIG. 5 illustrates a perspective view showing the camper truck bed shell being used as boat on a body of water in accordance with one embodiment of the present invention; and

FIG. 6 illustrates a perspective view showing the floating boat with an integrated outboard motor for automatic operation in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a device that can be carried easily on a truck and can also be used as a boat. There is also a long felt need in the art for a lightweight device that can be stored on truck bed and easily removed to be used as boat. Additionally, there is a long felt need in the art for a unique camper truck bed shell for all types of pickup trucks that can be converted into a small fishing boat. There is also a long felt need in the art for a camper truck bed shell that can be easily flipped upside-down from the truck bed rails and onto the water. Further, there is a long felt need in the art for an improved truck bed cover that eliminates the use of separate boats for fishing. Furthermore, there is a long felt need in the art for a device that looks like a regular camper truck bed shell which may be flipped onto the surface of the body of water to be used as a small fishing boat. Finally, there is a long felt need in the art for a novel camper truck bed shell that prevents individuals from having to haul extremely heavy and bulky fishing boats with a pickup truck.

The present invention, in one exemplary embodiment, is a one-piece camper truck bed shell operatively and detachably placed on a truck bed. The camper truck bed shell is adapted to cover truck bed in an installed position and is placed on the truck bed using a pair of pivoting sliding rails, the sliding rails are pivotally fastened to the rear ends thereof to the truck bed using hinges, wherein the camper truck bed shell is lifted along the pivotally fastened hinges to depart away from the truck bed and the camper truck bed shell is slid along the sliding rails to detach the camper truck bed shell, wherein the camper truck bed shell is configured to be used as a boat on a body of water and includes at least one seat for accommodation of users.

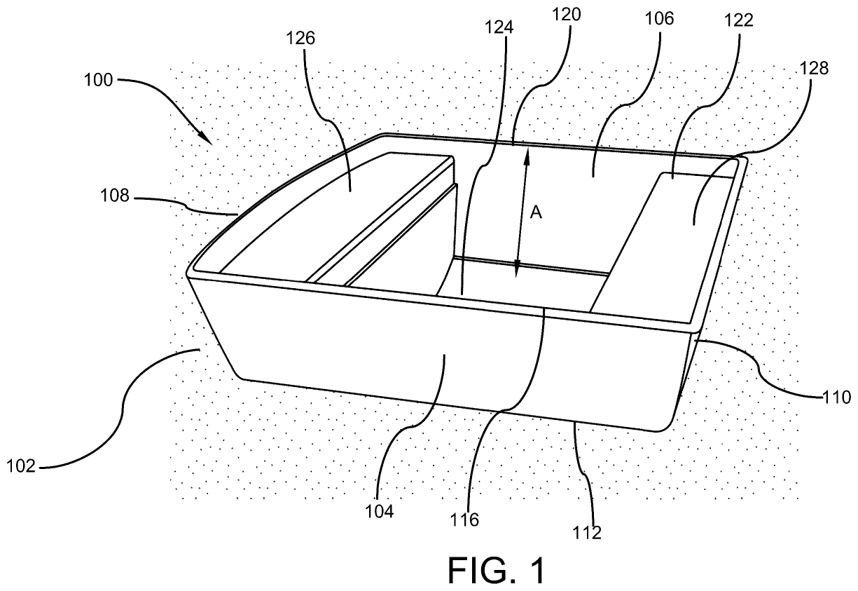

Referring initially to the drawings, FIG. 1 illustrates a perspective view of the floating camper truck bed shell of the present invention in accordance with the disclosed architecture. The floating camper truck bed shell 100 of the present invention is designed as a unique camper truck bed shell that can be used as a small fishing boat in addition to conventional use as a camper truck bed shell for pickup trucks. In the present embodiment, the camper truck bed shell 100 is shown in an upright position and is used as a boat in the illustrated position. More specifically, the floating camper truck bed shell 100 can be detachably attached to a pickup truck and includes a floating body 102 having a pair of side walls 104, 106, a front wall 108, a rear wall 110, and a top wall 112. The top wall 112 is designed to provide an adequate buoyant force for the camper truck bed shell 100 to float on a water surface such as of a body of water like a river or a lake.

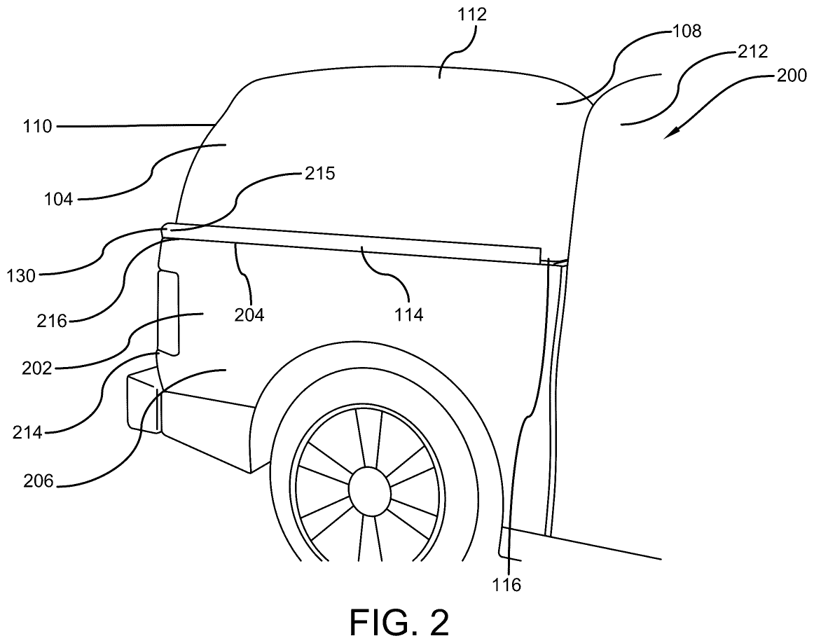

Referring to FIGS. 1 and 2, a first sliding rail 114 is disposed along the bottom edge 116 of the first side wall 104 and a second sliding rail 118 is disposed along the bottom edge 120 of the second side wall 106. The sliding rails 114, 118 help the camper truck bed shell 100 slide and rotate along the edges of a truck bed to transition the camper truck bed shell between an installed position and a pivoting position as described later in the disclosure. The camper truck bed shell 100 is designed to be detached from the sliding rails 114, 118 for use as an independent boat.

The camper truck bed shell 100 includes at least one ergonomic and soft seating platform 122 disposed in the inner area 124 thereof. The seating platform 122 is used for sitting by users during use of the camper truck bed shell 100 as a functional boat. The floating camper truck bed shell 100 can be designed for pickup truck beds of different sizes and can be made of lightweight material for floating on a body of water. The seating platform 122 can include separate seats 126, 128 along the front wall 108 and the rear wall 110 of the camper truck bed shell 100 enabling uniform distribution of the weight of the users sitting in the camper truck bed shell 100 when used as a functional boat.

FIG. 2 illustrates a perspective view of the floating camper truck bed shell of the present invention installed on a truck bed in accordance with the disclosed structure. The floating camper truck bed shell 100 is installed on the truck bed 202 of a pickup truck 200 for easy carriage. The first sliding rail 114 is positioned on the top edge 204 of the first side surface 206 of the truck bed 202 and the second sliding rail 118 is positioned on the top edge 208 of the second side surface 210 of the truck bed 202. In the installed position, the front wall 108 is positioned near the truck cabin 212 and the rear wall 110 is positioned on the rear wall 214 of the truck bed 202. The camper truck bed shell 100 can have a height (Arrow A) of up to three feet for accommodating legs of a user as illustrated later in the disclosure.

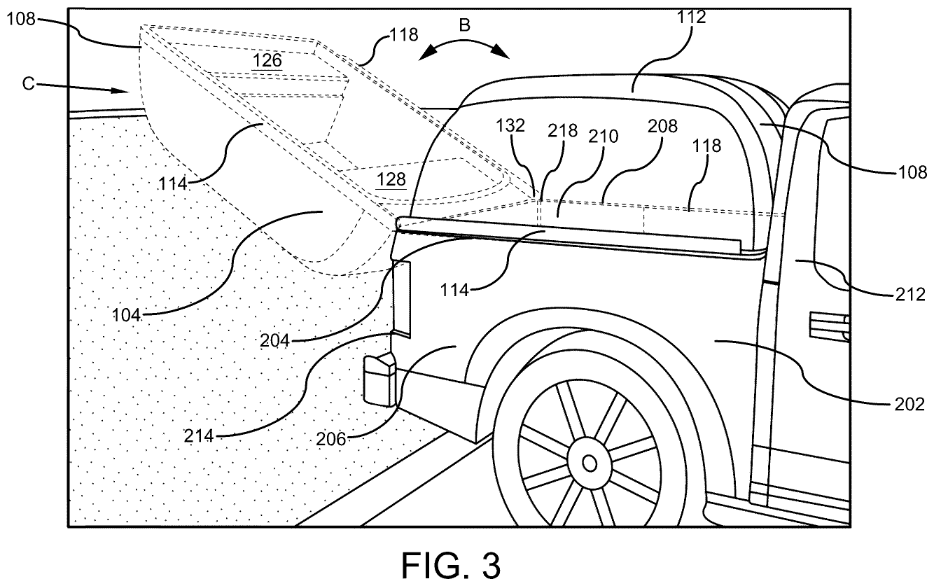

The rear end 130 of the first sliding rail 114 is pivotally fastened using a hinge 215 to the rear end 216 of the top edge 204 of the truck bed 202 and the rear end 132 of the second sliding rail 118 is pivotally fastened to the rear end 218 of the opposite top edge 208 of the truck bed 202. The camper truck bed shell bed 100 is adapted to pivotally lift along the pivotally fastened rear ends 130, 132 to transition the camper truck bed shell bed 100 from the installed position to a pivoting position as described in FIG. 3.

FIG. 3 illustrates a perspective view of the floating camper truck bed shell of the present invention in a pivoting position in accordance with the disclosed structure. For use of the camper truck bed shell 100 as a boat and to detach the camper truck bed shell 100 from the truck bed 202, the camper truck bed shell 100 is flipped over (in the direction indicated by Arrow B) from the front wall 108. The sliding rails 114, 118 remain attached to the rear ends 216, 218 of the truck bed 202 and the camper truck bed shell 100 rotates to depart away from the truck bed 202.

During rotation of the camper truck bed shell 100 from the installed position to the pivoting position (Arrow C), the floating body 102 does not slide along the sliding rails 114, 118. In the preferred embodiment, the truck 200 is positioned with the rear wall 214 of the truck bed 202 positioned toward a body of water and then, the camper truck bed shell 100 is flipped over to transition from the installed position to the pivoting position.

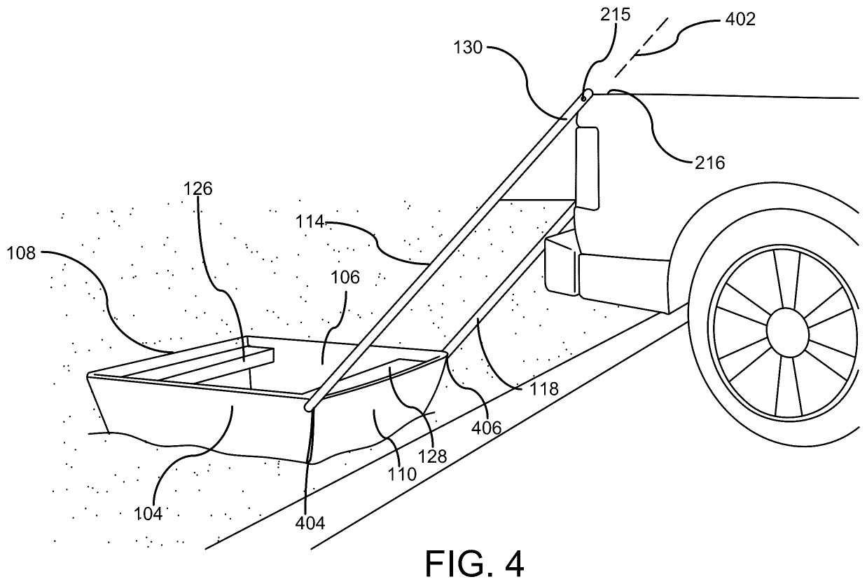

FIG. 4 illustrates a perspective view showing the camper truck bed shell of the present invention being flipped onto a water surface to function like a boat in accordance with one embodiment of the present invention. The sliding rails 114, 118 acting as a hitch are rotated along the respective pivoting rear ends 130, 132 thereof to rotate along the floating cab 100 along the imaginary axis 402. The sliding rails 114, 118 are rotated to touch a surface or a body of water and then the floating cab 100 slides along the sliding rails 114, 118 and detaches from the sliding rails 114, 118 at the trailing ends 404, 406 respectively for use as a boat in the water body. The floating cab 100 may not automatically slide down the rails 114, 118 and may be pushed down towards the ground along the rails 114, 118. The floating cab 100 when detached from the rails 114, 118 can float on water and can be used as a boat.

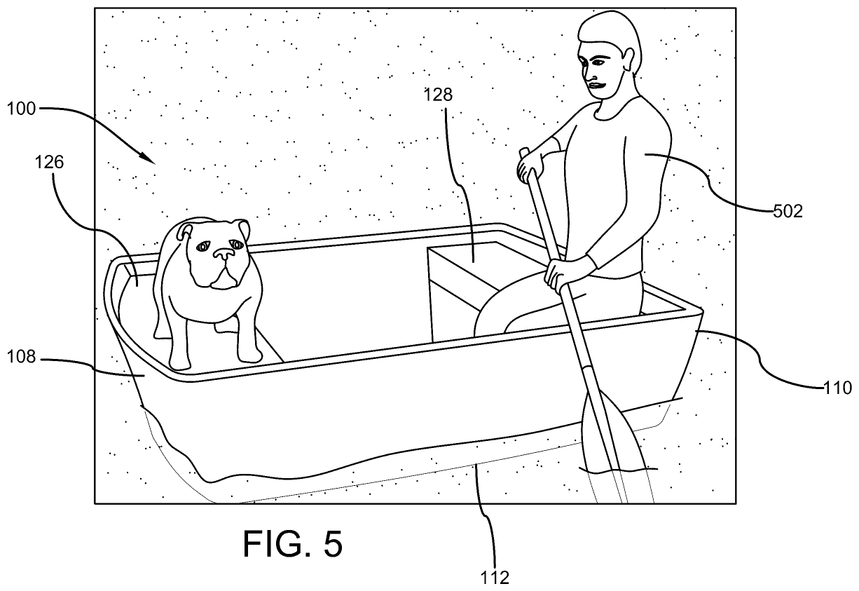

FIG. 5 illustrates a perspective view showing the camper truck bed shell being used as boat on a body of water in accordance with one embodiment of the present invention. As illustrated, the floating cab 100 floats on the top wall 112 and the seats 126, 128 are used for sitting in the boat such for piloting the boat. In the present embodiment, the floating boat 100 is manually piloting by a user 502. After use, the floating cab 100 can be placed on the rails 114, 118 and slid upward. The sliding rails 114, 118 and the floating cab 100 can be flipped back to transition into the installed position.

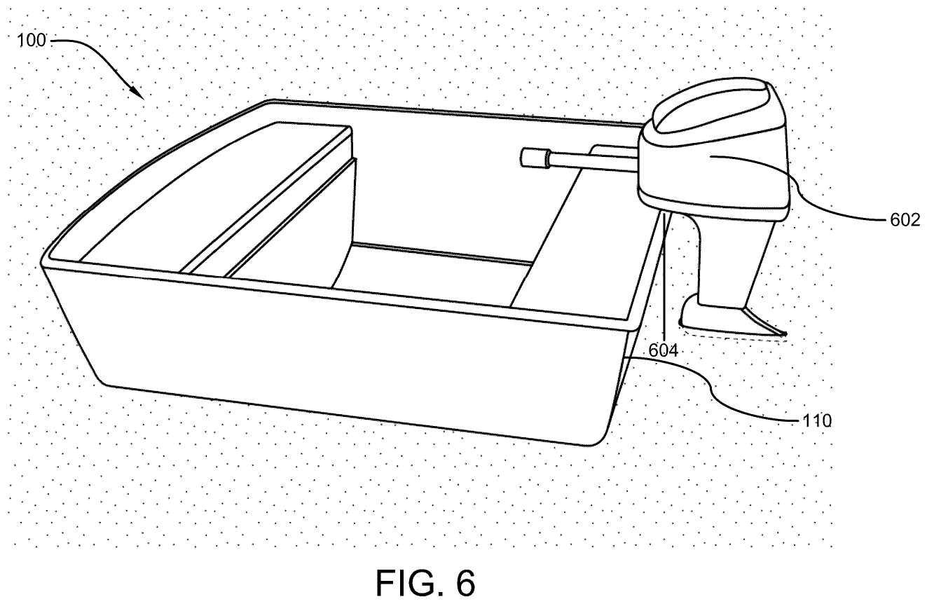

FIG. 6 illustrates a perspective view showing the floating boat with an integrated outboard motor for automatic operation in accordance with the disclosed structure. In the present embodiment, an outboard motor device 602 is attached to the rear wall 110 of the floating cab device 100. The outboard motor device 602 is specially designed to operate the floating cab 100 and eliminates manual operation for floating the floating cab 100. The floating boat 100 can have a notch 604 for detachably securing the motor device (i.e., on-board motor) 602.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “floating cab”, “floating cab device”, “floating camper truck bed shell”, and “camper truck bed shell” are interchangeable and refer to the floating camper truck bed shell 100 of the present invention.

Notwithstanding the forgoing, the floating camper truck bed shell 100 of the present invention can be of any suitable size and configuration as is known in the art without affecting the overall concept of the invention, provided that it accomplishes the above stated objectives. One of ordinary skill in the art will appreciate that the floating camper truck bed shell 100 as shown in the FIGS. are for illustrative purposes only, and that many other sizes and shapes of the floating camper truck bed shell 100 are well within the scope of the present disclosure. Although the dimensions of the floating camper truck bed shell 100 are important design parameters for user convenience, the floating camper truck bed shell 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A floating camper truck bed shell comprising:
a truck bed shell;
a floating body;
a first side wall;
a second side wall;
a front wall;
a rear wall; and
a top wall;
wherein said first side wall having a first sliding rail along a bottom edge of said first side wall;
wherein said second side wall having a second sliding rail along a bottom edge of said second side wall;
wherein said first sliding rail and said second sliding rail for sliding said truck bed shell on the edges of a truck bed;
wherein said truck bed shell rotatable on the edges of the truck bed for transitioning said truck bed shell from an installed position to a removed position; and
further wherein said floating body floats said truck bed shell in a body of water in the removed position.

2. The floating camper truck bed shell of claim 1, wherein said truck bed shell detachable from said first sliding rail and said second sliding rail.

3. The floating camper truck bed shell of claim 1, wherein said truck bed shell having at least one seating platform integrated between said first side wall and said second side wall.

4. The floating camper truck bed shell of claim 3, wherein said at least one seating platform proximal to one of said front wall and said rear wall.

5. The floating camper truck bed shell of claim 4, wherein said truck bed shell having a second seating platform integrated between said first side wall and said second side wall.

6. The floating camper truck bed shell of claim 5, wherein said second seating platform proximal to one of said front wall and said rear wall.

7. A floating camper truck bed shell comprising:
a truck bed shell;
a floating body;
a first side wall;
a second side wall;
a front wall;
a rear wall; and
a top wall;
wherein said first side wall having a first sliding rail along a bottom edge of said first side wall;
wherein said second side wall having a second sliding rail along a bottom edge of said second side wall;
wherein said first sliding rail and said second sliding rail for sliding said truck bed shell on the edges of a truck bed;
wherein said truck bed shell rotatable on the edges of the truck bed for transitioning said truck bed shell from an installed position to a removed position;
wherein said floating body floats said truck bed shell in a body of water in the removed position; and
further wherein said truck bed shell transitions from said truck bed shell to a boat.

8. The floating camper truck bed shell of claim 7, wherein said first side wall and said second side wall having a height up to 3 feet.

9. The floating camper truck bed shell of claim 8, wherein said truck bed shell detachable from said first sliding rail and said second sliding rail.

10. The floating camper truck bed shell of claim 9, wherein said truck bed shell having at least one seating platform integrated between said first side wall and said second side wall.

11. The floating camper truck bed shell of claim 10, wherein said at least one seating platform proximal to one of said front wall and said rear wall.

12. The floating camper truck bed shell of claim 11, wherein said truck bed shell having a second seating platform integrated between said first side wall and said second side wall.

13. The floating camper truck bed shell of claim 12, wherein said second seating platform proximal to one of said front wall and said rear wall.

14. A floating camper truck bed shell comprising:
a truck bed shell;
a floating body;
a first side wall;
a second side wall;
a front wall;
a rear wall; and
a top wall;
wherein said truck bed shell rotatable on the edges of the truck bed for transitioning said truck bed shell from an installed position to a removed position;
wherein said floating body floats said truck bed shell in a body of water in the removed position; and
further wherein said truck bed shell transitions from said truck bed shell to a boat and said top wall of said truck bed shell is a floor of the boat.

15. The floating camper truck bed shell of claim 14, wherein said first side wall having a first sliding rail along a bottom edge of said first side wall, wherein said second side wall having a second sliding rail along a bottom edge of said second side wall, and further wherein said first sliding rail and said second sliding rail for sliding said truck bed shell on the edges of a truck bed.

16. The floating camper truck bed shell of claim 15, wherein said first sliding rail hingedly pivotable to a rear end of a top edge of a truck bed, and further wherein said second sliding rail hingedly pivotable to a rear end of another top edge of the truck bed.

17. The floating camper truck bed shell of claim 15, wherein said truck bed shell detachable from said first sliding rail and said second sliding rail.

18. The floating camper truck bed shell of claim 15, wherein said truck bed shell having at least one seating platform integrated between said first side wall and said second side wall.

19. The floating camper truck bed shell of claim 18, wherein said truck bed shell having a second seating platform integrated between said first side wall and said second side wall.

20. The floating camper truck bed shell of claim 19, wherein said second seating platform proximal to one of said front wall and said rear wall.
